(19) United States
(12) Patent Application Publication
(10) Pub. No.: US 2015/0134370 A1
(43) Pub. Date: May 14, 2015

(54) DECISION SUPPORT SYSTEM AND METHOD FOR PROVIDING A CASH VALUE LIFE INSURANCE POLICY USING REDUCED RISK PREMIUM FINANCE

(71) Applicant: Robert Strauss, South Salem, NY (US)

(72) Inventor: Robert Strauss, South Salem, NY (US)

(21) Appl. No.: 14/537,946

(22) Filed: Nov. 11, 2014

Related U.S. Application Data
(60) Provisional application No. 61/902,619, filed on Nov. 11, 2013.

(51) Int. Cl. G06Q 40/08

(52) U.S. Cl. CPC G06Q 40/08
USPC 705/4

(57) ABSTRACT

Decision support systems and methods are provided for reducing the risk of financing premiums for a cash value life insurance policy. Information including a projected issuance date, a projected third-party loan payoff date, and a projected policy maturity date is used to underwrite an application for the insurance policy. Leverage method steps include determining a third-party loan amount to fund a policy premium. Arbitrage method steps include determining a participating policy loan amount sufficient to provide an early third-party loan exit strategy, thereby significantly reducing durational risk by funding the third-party loan amount at the projected third-party loan payoff date. The participating loan amount may be loaned at a maximum participating loan rate that is less than an interest rate for the third-party loan and/or less than a cash value earnings rate for the policy. Tax benefit methods steps may include scheduling periodic policy loan distributions.

### RELATED APPLICATIONS

This application claims the benefit under 35 U.S.C. §119(e) of U.S. Provisional Patent Application Ser. No. 61/902,619 filed by the inventors of the present application on Nov. 11, 2013, and titled System For Insurance Premium Finance Planning And Associated Methods, the entire content of which is incorporated herein by reference except to the extent that disclosure therein is inconsistent with disclosure herein.

### FIELD OF THE INVENTION

The present invention relates to systems and methods for financial planning involving life insurance and, more specifically, to systems and methods for managing the risk of financing premiums for a cash-value life insurance policy.

### BACKGROUND

A cash value life insurance policy is a life insurance product that provides protection against the risk of death of an insured, and also that serves as an income tool during the life of the insured. Because cash value insurance combines a death benefit with an accumulation component (i.e., the cash value), such policies may be more expensive than policies that only cover the risk of death during a specified time period (e.g., term insurance) and particularly during an insured's younger years. Types of cash value life insurance include whole life, universal life, and variable life insurance.

Premium payments for a cash value life insurance policy generally may be allocated three ways: a first portion of each premium may pay for the actual insurance costs (e.g., the cost associated with a death benefit based on the age and health of the insured, as well as other risk factors), a second portion may pay for the insurance company's operating costs and profits, and a third portion of each premium may add to the policy's cash value.

Premiums are not the only contributor to cash value. For example, earnings also may add to the policy's cash value in the form of interest credited to the account as determined by the insurer. In the case of Fixed Indexed Universal Life Insurance (FIUL), for example, an earnings rate may be pegged to a financial index such as a stock, bond, or other interest rate index. Typically, that “crediting rate” will be limited by some upside cap or participation rate as it reflects the earnings of a particular index or blend of indices. Conversely, the insurer will typically guarantee a floor crediting rate of 0%, 1% or 2%. In the case of Whole Life Insurance, dividend rates that reflect the insurance company's own profitability will be used instead.

Individuals having high net worths who seek to purchase large premium cash value life insurance policies often find themselves with insufficient liquid assets to cover the very costly premium payments for such policies. For these prospective buyers, premium financing may be an effective strategy for avoiding liquidation of assets in order to fund life insurance premiums. In a common model for premium financing, an insured may borrow money from a lender who is unrelated to the insurer issuing the policy. In certain premium financing models, the life insurance policy itself may be used as collateral for the borrowed money. Various approaches to financing insurance policy premiums exist in the art.

U.S. Patent Application Publication No. 2008/0109333 by Camp et al. discloses a method and system for financing premiums for a life insurance policy using taxable variable rate bonds obtained from a bond issuing entity. The method may include creating an interest earning bond fund with the taxable variable rate bonds and paying the life insurance premiums from the bond fund. However, the Camp implementation does not mitigate the risk that the variable rate of the financing vehicle may unexpectedly rise faster than the rate at which the cash value of the policy increases.

U.S. Patent Application Publication No. 2013/0090951 by Carias et al. discloses a system and method for financing insurance policy premiums that seek to transfer interest rate risk from an insured to a fixed income investor by employing a collateral assignment of the life insurance from the insured to the investor (i.e., a premium financing company). The insured's ownership rights are transferred as an additional security or collateral for the loan from the premium financing company. However, delegation and reversion of ownership interest in an insurance policy among multiple contractually-bound entities, in addition to the insured, creates management complexity.

The insurance premium finance systems and methods disclosed in U.S. Patent Application Publication No. 2009/0048956 by Sprowl seek to eliminate the traditional premium finance company from the process, and to establish a contractual, operational, and financially beneficial relationship between insurance agents and lending institutions (e.g., banks, financial institutions, lenders, and/or credit unions) identified as premium finance funding companies (PFFCs). However, like the Carias implementation, the systems and methods described in the Sprowl disclosure feature the complex transfer of control of ownership, profits, and servicing of a loan associated with the subject insurance policy to the PFFC.

None of the premium financing implementations described above include a premium financing “exit strategy” designed to maintain and exploit the cash value of a life insurance policy for the benefit of an insured. More specifically, none of the premium financing implementations described above address the risks and the opportunities faced by the insured when accessing the cash value of a policy.

For example, a policyholder may access cash value accumulations within the policy reserves through withdrawals, policy loans, and/or partial or full surrender of the policy. Withdrawals may be tax free up to the point of total premiums paid, but may be treated as taxable to the extent that they exceed the basis in the policy. (For purposes of definition, the basis may be computed as the amount of premiums the policyholder paid into the policy net of any previous dividends and tax-free withdrawals.) Also, if the policyholder makes a withdrawal during a contractually set initial period (typically the first 15 years of the policy) and the withdrawal causes a reduction in the policy's death benefit, some or all of the withdrawn cash may be subject to taxation.

Instead of making a withdrawal, the policyholder may gain tax-free access to cash value beyond the policy basis by borrowing against the accrued cash value of the life insurance policy. Most cash value policies allow the policyholder to borrow money from the issuer at an agreed upon policy loan interest rate using the cash accumulation account as collateral. Generally, policy loan interest is not actually paid by the policyholder, but is added to the amount of the loan. Furthermore, the terms of the loan may not require the policyholder to repay the amount borrowed against the life insurance policy loan. But if the policyholder dies, the death benefit is reduced by the amount of any outstanding policy loan balance. The impact of accessing cash value in a life insurance policy may vary depending on whether the policy is of a “participating” type or a “non-participating” type. (Whole life policies refer to these as “non-direct recognition” or “direct recognition” loans. For simplicity, hereinafter the terms participating and non-participating are used, without meaning to exclude whole life insurance.)

A loan against a non-participating policy reduces the cash value of the policy and the money being borrowed no longer participates in an index strategy. Therefore, loaned funds are charged interest but are not credited for earnings purposes. Non-participating loans stress a cash value insurance policy and hurt performance over the long term. More specifically, non-participating loans function much like withdrawals, except that such loans are tax free as long as the policy is never surrendered or allowed to lapse.

By comparison, participating policy loans are less stressful to a cash value insurance policy because money is borrowed not from the policy but from the general account of the insurer. Therefore, the borrowed amount remains in the cash value account and continues to participate in the equity markets (i.e., continues to receive earnings credits as it is being charged loan interest).

A policyholder may cash in a policy by surrendering the policy to the insurer in return for the policy's cash surrender value (as reduced by the amount of any outstanding policy loan plus interest). A policy may lapse if premiums are not paid and the policy terminates because any policy benefits are exhausted as a result. If the policy lapses, taxes may be due on an outstanding policy loan to the extent of gain in the policy. Also, if an amount borrowed plus interest ever equals or exceeds the cash surrender value, the policy may terminate if additional amounts are not paid into the life insurance policy.

Managing life insurance policies for which policyholders take policy loans is difficult compared to managing policies with no indebtedness. To understand policy effects clearly, policyholders require illustrations (called “schedules”) showing future policy values in the presence of policy loans. Generalizing is difficult because companies, as well as policies within companies, may apply different rules for handling loans and withdrawals that cannot be intuitively inferred. Employment of cash value access in addition to premium financing further complicates policy management. A need exists for improved systems and methods for managing and communicating the impact of premium financing and of cash value access on the income and death benefit generated by a cash value life insurance policy, and for generation of planning schedules illustrating the same.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the foregoing in mind, it is therefore an object of the present invention to provide systems and methods for insurance premium finance planning. More specifically, the present invention may advantageously provide decision support for reducing the risk of premium financing while managing the income and death benefit generated by a cash value life insurance. The decision support capability of the planning support may advantageously apply leverage during an initial policy period to fund life insurance premiums that a prospective insured would otherwise find to be prohibitively expensive. Furthermore, the decision support capability of the planning support may also advantageously facilitate arbitrage during a second policy period by replacing the initial premium financing with a participating policy loan that features more beneficial terms that the insured may exploit. Also, the decision support capability of the planning support may further advantageously secure tax advantages during a policy-ending distribution period by scheduling access to cash value in a way that ensures the insured avoids penalty and/or policy lapse.

These and other objects, features, and advantages according to the present invention are provided by a system that may be implemented as a non-transitory computer-readable medium storing instructions that define decision support for providing a cash value life insurance policy using reduced-risk premium financing. The system may be configured to execute instructions that may cause a processor to perform the steps of receiving an application for insurance coverage and underwriting the application in accordance with risk factors.

The application may include application information that may comprise a projected issuance date, a projected third-party loan payoff date, and a projected policy maturity date. The application information may further comprise a premium payment election defined as a single premium payment or a plurality of partial premium payments. The application information may further comprise a premium financing election defined as a single third-party loan or a plurality of third-party loans.

The system may be further configured to execute the instructions for underwriting the application by performing some combination of the steps of computing a policy premium, computing a third-party loan amount sufficient to fund the policy premium during a leverage period, computing an accrued interest amount based on the third-party loan amount, computing a participating policy loan amount sufficient to fund an outstanding loan amount on the projected third-party loan payoff date, and issuing the cash value life insurance policy upon receipt of a first payment toward the policy premium. The leverage period may be defined as the projected policy issuance date through the projected third-party loan payoff date. The outstanding loan amount may comprise the third-party loan amount and/or the accrued interest amount.

The system may be further configured to execute instructions that may cause the processor to perform the step of computing an interest rate differential between the single third-party loan and the plurality of third-party loans. The system also may be further configured to execute instructions that may cause the processor to perform the steps of opening a premium deposit fund (PDF) account, and receiving into the PDF account a deposit amount equal to the third-party loan amount.

The system may be further configured to execute the instructions for computing the participating loan amount by performing some combination of the steps of computing a maximum participating loan rate that is less than an interest rate for the third-party loan, and computing an earnings rate that is greater than the maximum participating loan rate. The maximum participating loan rate may comprise a guaranteed fixed loan interest rate.

The system may be further configured to execute the instructions for computing a periodic distribution amount and a projected distribution initiation date. The periodic distribution amount may comprise a variable distribution amount, and the system may be further configured to execute the instructions for performing the step of scheduling the periodic distribution amount for deduction from a cash value amount of the cash value life insurance policy between the projected participating policy loan date and a cash value growth threshold date. Also, the periodic distribution amount may comprise a fixed distribution amount, and the system may be further configured to execute the instructions for performing the step of scheduling the fixed distribution amount for deduction from a cash value amount of the cash value life insurance policy between a cash value growth threshold date and the projected policy maturity date.

A method aspect of the present invention implements decision support for providing a cash value life insurance policy using reduced-risk premium financing. The method may include receiving an application including application information comprising a projected issuance date, a projected third-party loan payoff date, and a projected policy maturity date; and underwriting the application in accordance with risk factors. The underwriting method step may include determining a policy premium, determining a third-party loan amount sufficient to fund the policy premium during a leverage period defined as the projected policy issuance date through the projected third-party loan payoff date, determining a participating policy loan amount sufficient to fund an outstanding loan amount on the projected third-party loan payoff date, the outstanding loan amount comprising the third-party loan amount, and issuing the cash value life insurance policy upon receipt of a first payment toward the policy premium.

### BRIEF DESCRIPTION OF THE DRAWINGS

FIG. 1 is a schematic block diagram of a decision support system to provide a cash value life insurance policy using reduced risk premium finance according to an embodiment of the present invention.

FIG. 2 is a diagram illustrating exemplary data structures of the decision support system depicted in FIG. 1.

FIG. 3 is a flow chart illustrating a method of providing a cash value life insurance policy using reduced risk premium finance according to an embodiment of the present invention.

FIG. 4 is a diagram illustrating an exemplary system interface for financial data input as used in connection with the decision support system depicted in FIG. 1.

FIG. 5 is a flow chart illustrating a method of return calculation as used in connection with the decision support system depicted in FIG. 1.

FIG. 6A is a diagram illustrating an exemplary system interface for displaying internal rate of return (IRR) as used in connection with an insurance premium finance planning system according to an embodiment of the present invention.

FIG. 6B is a diagram illustrating an exemplary system interface for displaying alternative investment comparisons as used in connection with an insurance premium finance planning system according to an embodiment of the present invention.

FIG. 6C is a diagram illustrating an exemplary system interface for displaying cash value comparisons as used in connection with an insurance premium finance planning system according to an embodiment of the present invention.

FIG. 6D is a diagram illustrating an exemplary system interface for displaying alternative benefits comparisons as used in connection with an insurance premium finance planning system according to an embodiment of the present invention.

FIG. 7 is a block diagram representation of a machine in the example form of a computer system according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Throughout this disclosure, the present invention may be referred to as an insurance premium finance planning system, an insurance premium finance decision support system, an insurance premium financing system, a finance planning system, a finance decision support system, a financing system, a decision support system, a planning system, a computer program product, a computer program, a product, a system, a device, and a method. Furthermore, the present invention may be referred to as relating to financing of premiums for cash value life insurance policies. Those skilled in the art will appreciate that this terminology does not affect the scope of the invention. For instance, the present invention may just as easily relate to convertible term life policies, variable life policies, and group life policies.

Example methods and systems for an insurance premium finance planning system are described herein below. In the following description, for purposes of explanation, numerous specific details are set forth to provide a thorough understanding of example embodiments. It will be evident, however, to one of ordinary skill in the art that the present invention may be practiced without these specific details and/or with different combinations of the details than are given here. Thus, specific embodiments are given for the purpose of simplified explanation and not limitation.

Some of the illustrative aspects of the present invention may be advantageous in solving the problems herein described and other problems not discussed which are discoverable by a skilled artisan.

An embodiment of the invention text, as shown and described by the various figures and accompanying text, provides an insurance premium finance planning system according to an embodiment of the present invention. The planning system may implement an automated method of applying leverage, arbitrage, and tax advantages to advantageously provide decision support for management of the income and death benefit generated by a cash value life insurance policy. The planning system also may generate planning schedules that may advantageously provide guidance on reducing the risk inherent to premium financing, and may advantageously illustrate the return on application of leverage, arbitrage, and tax advantages to exploit the income potential of a cash value life insurance policy.

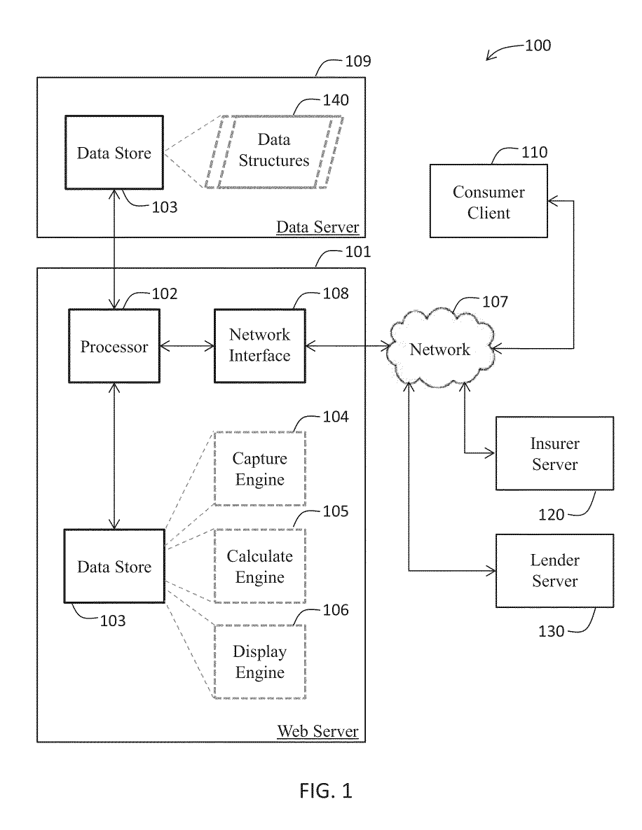

Referring more specifically to FIG. 1, the insurance premium finance planning (IPFP) system 100, according to an embodiment of the present invention, will now be discussed. The IPFP system 100 may include a web server 101, which may be in data communication with at least one consumer client 110. The IPFP system 100 also may be in data communication with one or more insurer servers 120 and/or one or more lender servers 130. Each consumer client 110 and, if applicable, each insurer and lender server 120, 130 may be configured in data communication with the web server 101 using a wide area network 107 such as the Internet. For example, and without limitation, the web server 101, consumer client 110, and insurer and lender servers 120, 130 also may have access to various third-party investment information sources via the Internet 107. Third-party investment information sources, for example, and without limitation, may include generally available applications (for example, and without limitation, web-based money rates tracking software maintained by The Wall Street Journal® at www.wsj.com) and proprietary applications (for example, and without limitation, investment planning software maintained internally by a given brokerage service engaged by a particular consumer).

The consumer client 110 may comprise a web browser and a communication application. The term “web browser” as used herein includes, but is not limited to, any application software or program (including mobile applications) designed to enable users to access, retrieve, and view documents and other digital content over a wide network 107 such as the Internet. The term “communication” as used herein includes, but is not limited to, electronic mail (email), instant messaging, mobile applications, personal digital assistant (PDA), a pager, a fax, a cellular telephone, a conventional telephone, television, video telephone conferencing display, other types of radio wave transmitter/transponders, and other forms of electronic communication. Those skilled in the art will recognize that other forms of communication known in the art are within the spirit and scope of the present invention.

Users of the consumer client 110 may be prospective life insurance product consumers. For example, and without limitation, consumers who may make use of the IPFP system 100 through their consumer clients 110 may include any person or entity contemplating the purchase of a cash value life insurance policy. Also for example, and without limitation, consumers may include insurance brokers and/or financial planning agents desiring to secure life insurance on behalf of others. Maintainers of the insurer server 120 may include providers of any type of cash value life insurance (e.g., a whole life policy). Maintainers of the lender server 130 may include providers of any type of loan product (e.g., a debt consolidation loan).

Continuing to refer to FIG. 1, the web server 101 may comprise a processor 102 that may accept and execute computerized instructions, and also a data store 103 which may store non-transitory data and instructions used by the processor 102. More specifically, the processor 102 may be configured to receive input from some number of consumer clients 110, as well as from insurer servers 120, lender servers 130, and/or third-party investment information sources (not shown), and to direct that input to the data store 103 for storage and subsequent retrieval. For example, and without limitation, the processor 102 may be in data communication with external computing resources 110, 120, and 130 through a direct connection and/or through a network connection 107 facilitated by a network interface 108. Also for example, and without limitation, the data store 103 may comprise multiple data stores hosted either locally on the web server 101, and/or remotely on a data server 109.

Capture engine instructions 104 may be stored in the data store 103 and may be retrieved by the processor 102 for execution. The capture engine 104 may be configured to advantageously automate the input of planning variables originating from the consumer client 110, the insurer server 120, and/or the lender server 130. Calculate engine instructions 105 also may be stored in the data store 103 and may be retrieved by the processor 102 for execution. The calculate engine 105 may advantageously automate creation of return schedules for self-financed insurance and, for comparison purposes, for one or more alternative investment vehicles. Display engine instructions 106 also may be stored in the data store 103 and may be retrieved by the processor 102 for execution. The display engine 106 may be configured to advantageously automate the presentation of the return for self-financed insurance and also, for example, and without limitation, for the alternative investment vehicles.

Those skilled in the art will appreciate, however, that the present invention contemplates the use of computer instructions that may perform any or all of the operations involved in financial planning decision support, including asset allocation, risk mitigation, and debt management. The disclosure of computer instructions that include capture engine instructions, calculate engine instructions, and display engine instructions is not meant to be limiting in any way. Those skilled in the art will readily appreciate that stored computer instructions may be configured in any way while still accomplishing the many goals, features and advantages according to the present invention.

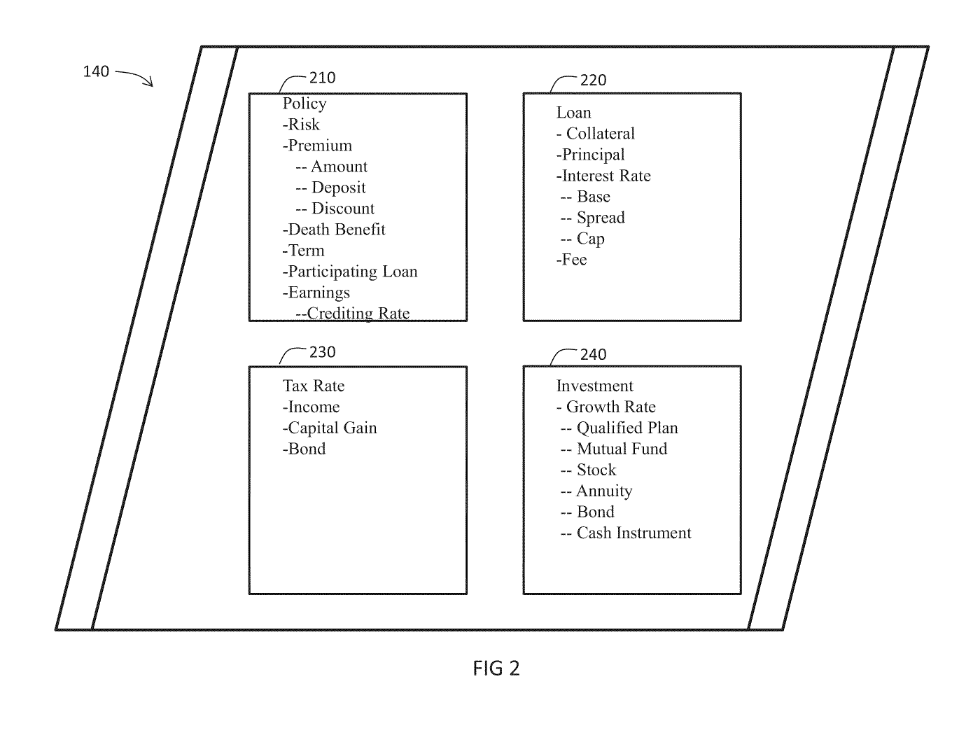

Continuing to refer to FIG. 1, and referring additionally to FIG. 2, the processor 102 on the web server 101 may write to the data store 103 on the data server 109 information about personal finance options of a given consumer (user), and may retrieve from the data store 103 that information that is pertinent to the plans and objectives of the consumer. Such information may be stored in one or more data structures 140. For example, and without limitation, the capture engine 104 may obtain from the data structure 140 policy information 210 for a cash value life insurance offering by a given insurer. Although the data structure 140 shown illustrates information that may be written to and/or retrieved from the data store 103 on the data server 109, employment of networking may permit the insurance premium finance planning system 100 to retrieve information about life insurance offerings directly from third-party information sources, thereby enhancing the timeliness and completeness of data used by the system 100.

Referring now more specifically to FIG. 2, the illustrated embodiment of a financial planning data structure 140 shows example data objects 210, 220, 230, 240 that may be pertinent to the personal finance requirements of a prospective consumer. Although the embodiment of the invention discussed herein describes the data storage and retrieval functionality performed by the capture engine 104, the calculate engine 105, and/or the display engine 106, those skilled in the art will readily appreciate that stored computer instructions and data objects may be configured in any way while still accomplishing the many goals, features, and advantages according to the present invention.

Continuing to refer to FIG. 2, the data structure for a cash value life insurance policy 210 will now be discussed. For example, and without limitation, the policy data structure 210 may comprise a set of parameters which may include cash value insurance product characteristics such as risk factors, premium, death benefit, policy term, and participating loan factors. The risk factors, such as age and health of the prospective policyholder (hereinafter referred to as the insured), are used during a selection process (i.e., underwriting) to determine the appropriate premium rate classification for the benefit being insured against. The premium required by the insurer as consideration for the insurance policy may be expressed as an amount to be paid by the insured. The death benefit may be expressed as an amount to be paid to a beneficiary of the insured in the event of the death of the insured. The policy term may be expressed as a duration during which the policy may remain active assuming that required premium payments are remitted to the insurer by the insured. The policy maturity date may be computed as a policy issue date plus an offset of the policy term. The participating loan factors establish the conditions under which the insured may borrow against the cash value of the insurance policy.

In one embodiment, the capture engine 104 may receive information on the required premium amount from the insurer server 120, and may write that information to the policy data structure 210 on the data store 103. For example, and without limitation, premium amount information may include payment terms including payment frequency which may occur on either a one-time basis (e.g. single premium payment) or a recurring, periodic basis (e.g., a plurality of partial premium payments). In another embodiment, the capture engine 104 may receive information on a deposit to be applied toward the premium amount, along with any premium discount to be recognized by the insurer for the deposit. In yet another embodiment, the participating loan may be characterized by loan parameters such as a maximum participating policy loan rate and dividend restrictions. In yet another embodiment, the capture engine 104 may receive from the insurer server 120 information on earnings potential for the cash value insurance policy, such as a crediting rate to be applied periodically to available reserves, and may write that information to the policy data structure 210 on the data store 103.

Continuing to refer to FIG. 2, the data structure for a loan instrument 220 will now be discussed. The loan instrument 220 data structure may specify the terms and conditions under which a given third-party lender may provide financing to a borrower. In the context of one embodiment of the present invention, the borrower may be the prospective insured. For example, and without limitation, the loan data structure 220 may list collateral, principal, interest rate, and fees associated with third-party financing. In one embodiment of the present invention, the interest rate may be characterized by a fixed base rate. In another embodiment of the present invention, the interest rate may be expressed as a base interest rate (e.g., LIBOR interest rate index) plus a spread. In yet another embodiment, the interest rate may be variable and expressed as a base rate with a spread that may be capped above the base rate. The loan data structure 220 also may comprise information regarding the lender offering the financing. For example, and without limitation, lender contact information may include the name of the lender, an email address, a telephone number, a mailing address, and/or any other type of communication address.

Continuing to refer to FIG. 2, the data structure for one or more tax rates 230 applicable to the prospective insured will now be discussed. The tax rate data structure 230 may specify the rates at which a consumer (defined as the insured in the context of an embodiment of the present invention) may be taxed. For example, and without limitation, the tax rate data structure 220 may list applicable income tax rates, capital gain tax rates, and rates for other taxable investments. The tax rate data structure 230 also may comprise information regarding taxing authorities. For example, and without limitation, taxing authority contact information may include the name of the authority, an email address, a telephone number, a mailing address, and/or any other type of communication address.

Continuing to refer to FIG. 2, the data structure for one or more alternative investment vehicles 240 will now be discussed. The investment data structure 240 may specify the growth rates the consumer (i.e., the insured) may expect from various investment vehicles. In one embodiment, the investment structure 240 may comprise the growth rate of an investment. For example, the growth rate may be tied to a particular investment vehicle, such as a qualified plan, mutual fund, stock, annuity, bond, and/or cash instrument. The investment data structure 240 also may comprise information regarding the entity offering the investment. For example, and without limitation, investment contact information may include the name of the investment entity, an email address, a telephone number, a mailing address, and/or any other type of communication address.

Those skilled in the art will appreciate, however, that the present invention contemplates the use of data structures that may store information supporting any or all of the operations involved in financial planning decision support, including price quotation, policy underwriting, brokerage services, tax planning, payment processing, and issue resolution. The disclosure of data structures that include personal finance scheduling factors is not meant to be limiting in any way. Those skilled in the art will readily appreciate that data structures may be configured in any way while still accomplishing the many goals, features and advantages according to the present invention.

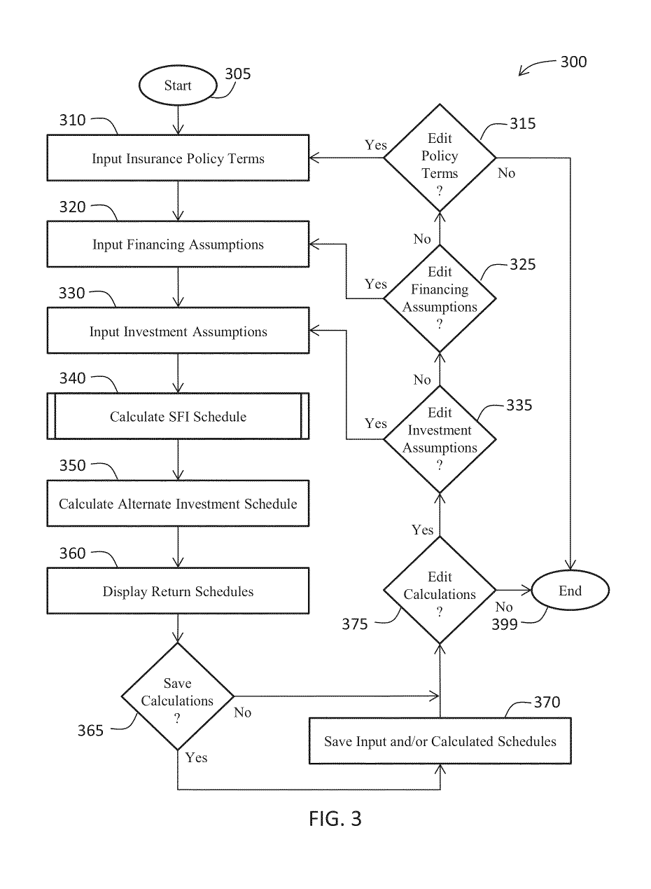

Referring now to FIG. 3, and continuing to refer to FIGS. 1 and 2, a method aspect 300 for financial planning decision support using the insurance premium finance planning (IPFP) system 100, according to an embodiment of the present invention, will now be discussed. In the methods illustrated herein, the capture engine 104, calculate engine 105, and display engine 106 executing on the processor 102 of the web server 101 may operate on the data structures 140 that may be located in the data store 103 of the data server 109. For example, and without limitation, a system user may employ the consumer client 110 to interact with the web server 101. The following illustrative embodiment is included to provide clarity for certain operational methods that may be included within the scope of the present invention. A person of skill in the art will appreciate additional databases and operations that may be included within the IPFP system 100 of the present invention, which are intended to be included herein and without limitation.

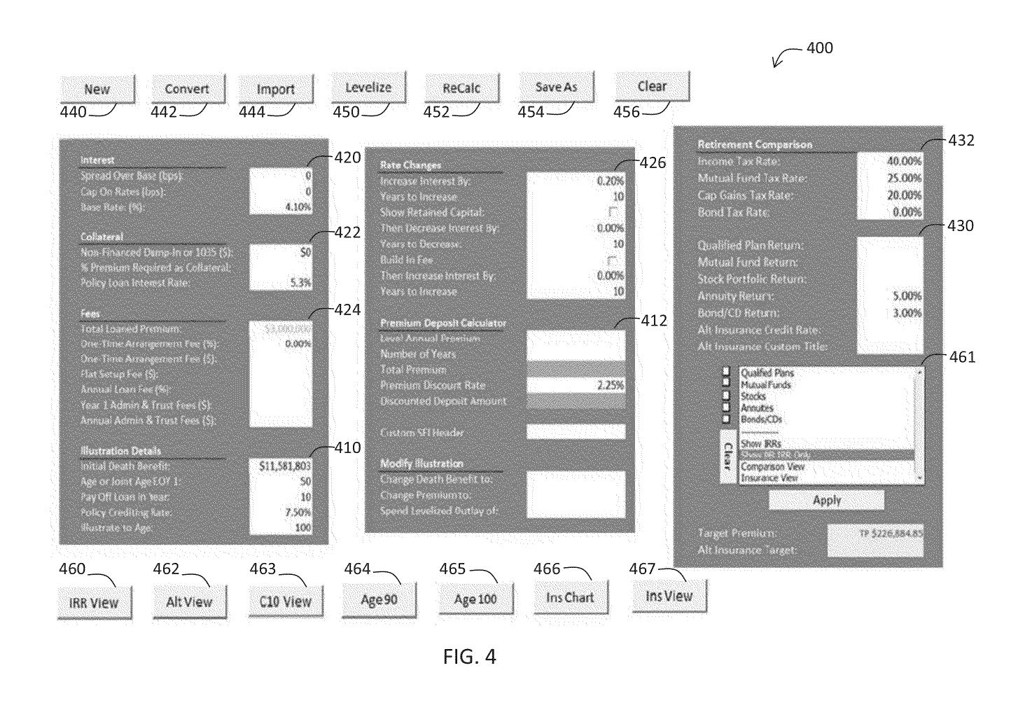

The entry of financial planning parameters into the data structure 140 from the consumer client 110 may be accomplished by the consumer using a system interface on the consumer client 110 to instantiate the data structure 140 and to transmit the financial planning parameters 210, 220, 230, and 240 through the network 107 to the web server's network interface 106. For example, and without limitation, the system interface 400 (as illustrated in FIG. 4) may be in the form of a web-based application accessible through a web browser on the consumer client 110. The processor 102 may route the personal finance information to the data store 103 on the data server 109.

Continuing to refer to FIG. 3, and referring additionally to FIGS. 1, 2, and 4, a method of inputting financial planning parameters using the insurance premium finance planning (IPFP) system 100, according to an embodiment of the present invention, will now be discussed. From the start at Block 305, the system 100 may receive as input the cash value life insurance policy terms (Block 310), premium financing assumptions (Block 320), and alternative investment assumptions (Block 330) required to calculate return schedules both for self-financed insurance (Block 340) and for some number of alternative investments (Block 350). The system 100 may display the calculated return schedules (Block 360) for comparison purposes.

More specifically, the capture engine 104 may receive as input the insurance policy provisions 210 for the cash value insurance product, and may record the same to the data store 103. As related above, the cash value insurance policy provisions 210 may include risk, premium, death benefit, term, participating loan, and earnings details. In one embodiment of the present invention, the insurance policy provisions 210 may be received from the insurer server 120 as recorded by the maintaining insurer. In another embodiment of the present invention, the insurance policy provisions 210 may be retrieved from an insurance instrument using an insurance company illustration conversion capability supported on the consumer client 110. For example, and without limitation, the conversion capability may identify an insurance company illustration system that employs a format and/or data model that the IPFP system 100 may be configured to support, may find and copy all relevant insurance policy data from the host illustration system, and may transfer those data to a uniform data sheet from which an import into the data structure 140 may be performed by the capture engine 104. In yet another embodiment of the present invention, the insurance policy terms for Block 310 may account for the expected tax burden 230 the insured may experience for taxable events such as early partial distributions and outstanding policy loans upon policy lapse.

At Block 320, the capture engine 104 may receive planning assumptions regarding third-party loan provisions 220 by which premiums for a cash value insurance product may be financed, and may record the same to the data store 103. As related above, the loan provisions 220 may include collateral, principal, interest, and fee details. For example, and without limitation, the loan provisions 220 may comprise lender terms assumptions received from the consumer using the consumer client 110. Also for example, and without limitation, the loan provisions 220 may be received from the lender server 130 as recorded by a responsible third-party lender.

At Block 330, the capture engine 104 may receive planning assumptions regarding the estimated growth rate 240 expected from investment vehicles entered by the consumer using the consumer client 110, and may record the same to the data store 103. These investment vehicles may be offered as alternatives to the cash value insurance product for return comparison purposes. As related above, the investment growth rate 240 may be tied to particular investment vehicle, such as a qualified plan, mutual fund, stock, annuity, bond, and/or cash instrument. Also included in the investment planning assumptions for Block 330 may be the expected tax burden 230 the consumer may experience for each alternative investment vehicle considered. In one embodiment of the present invention, assumptions related to investment growth rate 240 potential and to tax rate 230 ramifications may be transliterated from an investment vehicle prospectus by the consumer using the consumer client 110 to interact with the capture engine 104. In another embodiment of the present invention, the expected investment growth rate 240 and tax rate 230 may be retrieved by the capture engine 104 from third-party information sources (e.g., investment broker server, Internal Revenue Service server).

At Block 340, the calculate engine 105 may retrieve from the data store 103 the insurance policy provisions 210 for the cash value insurance product and the loan provisions 220 by which premiums for the cash value insurance product may be financed. Using these insurance policy terms and financing assumptions (captured at Blocks 310 and 320, respectively), the calculate engine 105 may generate a return schedule (described in greater detail below). Additionally, the calculate engine 105 may retrieve from the data store 103 the investment growth rates 240 expected from the alternative investment vehicles specified (as captured at Block 330), and may generate a return schedule for each (Block 350). At Block 360, the display engine 106 may create a display of the self-financed insurance return schedule along with the investment vehicle(s) return schedule(s) for comparison. For example, and without limitation, these schedules may be displayed on the consumer client 110 as an aid to financial planning decision support.

At Block 365, the user of the consumer client 110 may use the system interface 400 (as illustrated in FIG. 4) to elect to save (Block 370) the insurance policy terms, financing assumptions, and/or investment assumptions (from Blocks 310, 320, and 330, respectively) for later retrieval. For example, and without limitation, the processor 102 may write to the data store 103 (Block 370) the policy provisions 210 and loan provisions 220 used as input to Block 340 to calculate the self-financed insurance (SFI) schedule. Alternatively, or in addition, these provisions may be stored locally (Block 370) on the consumer client 100 for subsequent retrieval and use in further calculations. Also at Block 365, the user of the consumer client 110 may use the system interface 400 to elect to save to the data store 103 (Block 370) the generated self-financed insurance return schedule and/or alternative investment return schedule(s) for later retrieval. Alternatively, or in addition, one or more of these schedules may be stored locally (Block 370) on the consumer client 100 for subsequent retrieval.

At Block 375, the user of the consumer client 110 may choose not to edit and recalculate the self-financed insurance schedule and alternative investment schedules as displayed at Block 360, at which point the process may end at Block 399. Alternatively, the user of the consumer client 110 may employ the system interface 400 (as illustrated in FIG. 4) to elect to edit one or more of the insurance policy terms, financing assumptions, and/or investment assumptions (from Blocks 310, 320, and 330, respectively) as input to a recalculation of a self-financed insurance schedule and/or some number of alternative investment schedules at Blocks 340 and 350, respectively.

For example, and without limitation, the user may use the system interface 400 to elect to edit the investment assumptions at Block 335 (i.e., change the expected growth 240 and tax rate 230 factors for one or more alternative investment vehicles). This step may allow the user to leave the input insurance policy provisions 210 and loan provisions 220 unchanged for purposes of recalculating only the alternative investment schedule at Block 350. Alternatively, or in addition, the user may use the system interface 400 to elect to edit the financing assumptions at Block 325 (i.e., change the collateral, principal, interest rate, and/or fee for the third-party loan 220). This step may allow the user to leave the input insurance policy provisions 210 and investment provisions 220, 230 unchanged for purposes of recalculating only the self-financed insurance return schedule at Block 340. Alternatively, or in addition, the user may use the system interface 400 to elect to edit the insurance policy terms at Block 315 (i.e., change the risk, premium, death benefit, term, participating loan, and/or earnings terms for the policy 210). This step may allow the user to leave the input loan provisions 220 and investment provisions 220, 230 unchanged for purposes of recalculating only the self-financed insurance return schedule at Block 340.

For example, and without limitation, FIG. 4 illustrates one embodiment of a system interface 400 configured to support user input of policy terms, loan assumptions, and investment assumptions into the system 100. The following data entry fields may be supported by the system interface 400 for the capture of policy terms (Block 310):

Illustration Details 410: The user may enter the initial death benefit amount, the projected age of the insured as of the issue date, the term targeted for payoff of premium financing, the policy crediting rate for earnings purposes, and the policy maturity date (expressed as the number of years to use in generating records for the return schedule). If left blank, the capture engine 104 may automatically populate the system interface 400 with information based on data gathered from an input life insurance policy illustration as described above.

Premium Deposit Calculator 412: Some cash value insurance products allow for prepayment of premiums into a premium deposit fund (PDF) account, from which the insurer may pay premiums periodically on behalf of the policyholder. Prepaid premiums may result in the advantage of the lump sum deposited into the account being discounted by a certain percentage. The user may enter the level of periodic (e.g., annual) premiums due, the number of premiums to be paid, and the discount rate offered by the insurer as input to the calculation of the discounted deposit amount.

The following data entry fields may be supported by the system interface 400 for the capture of loan terms (Block 320):

Interest 420: The user may input the interest rate for third-party financing of the insurance premium. For example, and without limitation, a variable interest rate may be entered as a base interest rate plus a spread. Also for example, and without limitation, the variable interest rate may be capped at a maximum value above the initial base interest rate.

Collateral 422: The user may enter factors affecting loan collateral, such as a non-financed lump sum of money put into the insurance policy when coverage begins (called a dump-in), or of funds being transferred from another life insurance policy using a 1035 Exchange transaction. The maximum participating policy loan interest rate may also be entered using this data entry field.

Fees 424: The user may enter any lender fees, such as one-time arrangement fees expressed as a percentage or dollar amount, a flat setup fee, periodic (e.g., annual) loan fees, and administrative and trust fees. The total premium expected to be paid using a third-party loan may also be entered using this data entry field.

Rate Changes 426: The user may enter the expected rate of increase or decrease of third-party loan interest rates over multiple years, and may change the direction of interest rates multiple times. If left blank, the capture engine 104 may automatically populate the system interface 400 with default third-party loan interest rates and associated factors.

The following data entry fields may be supported by the system interface 400 for the capture of alternative investment assumptions (Block 330):

Growth Rates 430: The user may enter an expected growth rate for each of several types of investment vehicles, including qualified plans, mutual funds, stock portfolios, annuities, bonds and cash instruments. If left blank, the capture engine 104 may automatically populate the system interface 400 with a default growth rate for displayed comparison investments equal to the policy crediting rate.

Tax Rates 432: The user may input the income tax rate, capital gains tax rate, and bond tax rate the user expects to experience during the planning period. If left blank, the capture engine 104 may automatically populate the system interface 400 with default tax rates.

Continuing to refer to FIG. 4, for example, and without limitation, the following operators may be supported by the system interface 400 for the capture of required input (Blocks 310, 320, and/or 330):

New 440: This operator may allow the user to create a new blank data sheet with column headings ready to accept required input data for import by the system 100.

Convert 442: This operator may allow the user to scan a life insurance illustration for input data required by the system 100, and to filter out extraneous and repetitive information. The Convert operation may reformat the life insurance illustration into a recognizable data sheet ready for import.

Import 444: This operator may allow the user to transfer all information from the populated data sheet to the system 100, intelligently creating default assumptions based on imported data related to loan interest 420, collateral requirements 422, and alternative investment return estimates 430.

Continuing to refer to FIG. 4, the system interface 400 may be configured to support operators for calculation (Blocks 340 and 350) and recording (Block 370) of return schedules according to an embodiment of the present invention. The following operators may be supported by the system interface 400 to allow user-directed calculation and recording:

Levelize 450: This operator may allow the user to determine the amount of principal to be paid periodically (e.g., annually) with interest such that all third-party loan payments are equal and the loan balance at the end of the user-defined loan term may be equal to the original amount borrowed.

Recalc 452: This operator may allow the user to execute all schedule calculations on demand based on the most recently entered planning data and assumptions.

Save As 454: This operator may allow the user to save the data sheet with existing data and existing assumptions. Default settings may be saved for future use.

Clear 456: This operator may allow the user to clear existing input assumptions and restore default input assumptions.

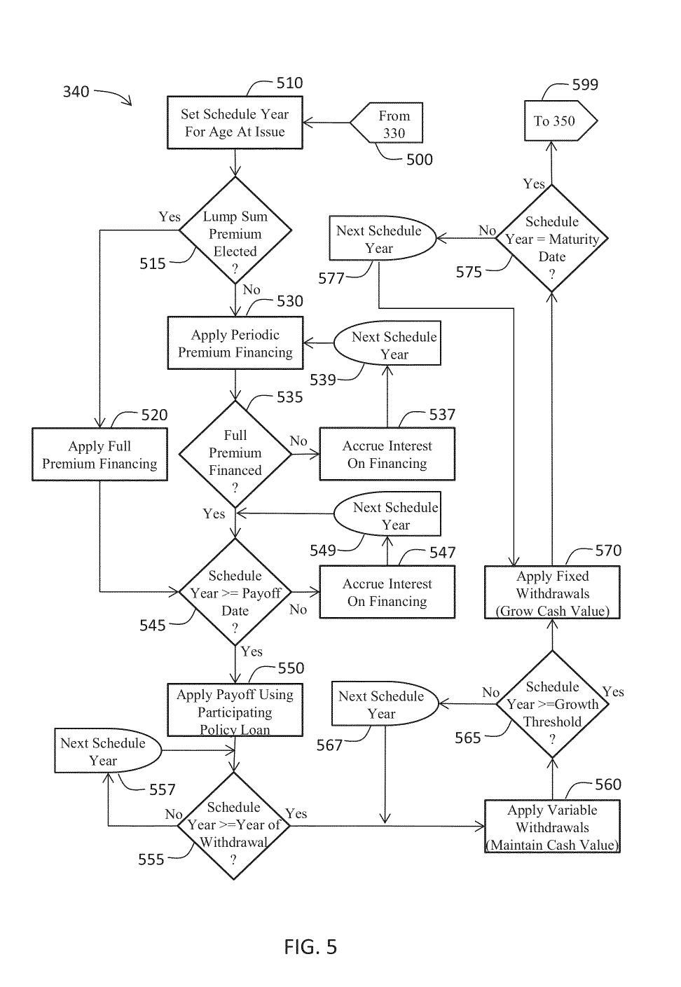

Referring now to FIG. 5 and beginning at Block 500, the calculate engine 105 may process the operations necessary to calculate a return schedule covering a term of a self-financed life insurance product. More specifically, the calculate engine 105 may create a schedule record for each year from a projected policy issuance date for the cash value life insurance policy through a projected policy maturity (e.g., termination) date. For example, and without limitation, at Block 510 the system 100 may receive a target age of the prospective insured at the projected date of policy issuance, and may set a schedule year variable to be equal to the year the prospective insured will achieve the target age. At Block 515, the calculate engine 105 may receive the election of the prospective insured related to a mode of premium payment. More specifically, the calculate engine 105 may determine if a single premium payment is to be made at issuance as a lump sum, or if periodic (e.g., annual) premium payments are to be spread across some portion of the term of the cash value life insurance policy. Whether a single lump sum or recurring annual payments, financing of premium payments may be assumed to be accomplished using leverage (e.g., a third-party loan). For example, and without limitation, the third-party loan may be provided by a bank, an employer, a relative, or other interested party. Also for example, and without limitation, interest charged by the insurer may be added to the amount of the policy loan rather than paid directly by the prospective insured.

If the prospective insured elects periodic premium financing, the calculate engine 105 may populate the record for the current schedule year with a financed payment of that year's periodic premium (Block 530). Until the calculate engine 105 detects that full premium for the cash value life insurance policy is paid through financed periodic payments (Block 535), the calculate engine 105 may create a record for each year of the policy (Block 539) and may populate that record with the newly financed premium payment (Block 530) as well as the accrued interest on all outstanding financing (Block 537). Alternatively, if the prospective insured elects lump sum premium financing, the calculate engine 105 may populate the record for the current schedule year with a financed one-time payment of the total policy premium (Block 520).

More specifically, the prospective insured may elect either to borrow to finance premiums each year as they become due to the insurer (Block 530), or to borrow all premiums up front (Block 520) and make a single deposit into a premium deposit fund (PDF) managed, for example, and without limitation, by the insurer. The first approach may gradually add to the principal of the third-party loan, resulting in interest paid on premiums only as needed. The second approach may result in the policyholder paying interest on both used and unused premiums, but may merit lower interest rates offered by lenders for the larger loan amount. Referring additionally to FIG. 4, the prospective insured may use the PDF Calculator 412 to determine whether the interest rate differential between the two approaches is sufficient to warrant up front borrowing. If borrowing to cover all premiums at once is warranted, the prospective insured may use the PDF Calculator 412 to determine the lump sum amount that needs to be deposited into a PDF account by the prospective insured based on a levelized premium payment schedule and user-defined discount rate.

Referring again to FIG. 5, after the full premium for the cash value life insurance policy has been financed (whether by lump sum at Block 515 or by periodic payments at Block 535), the calculate engine 105 may create a record for each year (Block 549) prior to the projected date specified by the user for payoff of the premium financing (Block 545). For example, and without limitation, the projected third-party loan payoff date may be set at ten (10) years from the projected issuance date of the policy, thereby establishing schedule certainty as to third-party loan payoff). Until the calculate engine 105 detects that the user-specified projected third-party loan payoff date is reached (Block 545), the calculate engine 105 may populate each yearly record with the accrued interest on all outstanding financing (Block 547).

Upon detection by the calculate engine 105 that the user-specified projected third-party loan payoff date is reached (Block 545), the calculate engine 105 may populate the record for the payoff year with a payoff of the outstanding loan amount using funds from a participating policy loan (Block 550). For example, and without limitation, the maximum participating loan rate after the user-specified payoff date may be less than the interest rate of the third-party loan (e.g., arbitrage). More specifically, it is possible for borrowed funds to be charged an interest rate in any given year that is less than the same funds are being credited, thereby resulting in a positive spread, or arbitrage. If the participating policy loan interest rate is guaranteed to be fixed for the life of the contract at a relatively low interest rate, there is a much greater likelihood that the crediting rate will exceed the interest rate and create arbitrage in any given year. The high likelihood of arbitrage allows for a relatively large participating policy loan to be taken in a relatively short period of time to pay off the third-party loan, without causing long-term harm to the policy. Arbitrage may advantageously reduce the durational risk of premium financing, and furthermore may advantageously increase leverage by limiting the number of interest payments due before exiting the loan.

By applying a guaranteed fixed rate low interest participating policy loan that may remain at a first rate for the life of the insurance contract, and by applying to borrowed funds an earnings rate pegged to equity markets that may return at a second rate, the second rate should exceed the first rate resulting in arbitrage in many years. The present invention may take advantage of conditions that are favorable for arbitrage to schedule pay off of the initial third party loan early (e.g., by the user-specified projected payoff date defined above). Setting a short-duration third-party loan payoff date may advantageously allow the insured to pay off the third-party loan using funds from the participating policy loan without terminating the policy. Use of arbitrage may advantageously reduce the risk of premium financing, and ultimately may increase leverage by limiting the number of up-front interest outlay payments.

Continuing to refer to FIG. 5, the calculate engine 105 may create yearly records (Block 557) from the payoff date through the year when tax free policy loan distributions from cash reserves may be initiated (Block 555). For example, and without limitation, tax free policy loan distributions may be allowed starting 15 years from the issue date of the policy. Also for example, and without limitation, upon detection by the calculate engine 105 that the current schedule year is the projected year when partial, periodic distributions from the cash value account may be made by the policyholder without penalty (Block 555), the calculate engine 105 may populate the record for the first possible distribution year with a periodic distribution amount (Block 560). The periodic distribution amount applied by the calculate engine 105 may be less than a given year's cash surrender value remaining in the reserve account so as to avoid unintended termination of the policy. In one embodiment, the variable distribution amount may be calculated as a percentage of the cash surrender value that is greater than the indexed crediting rate, thus causing the cash surrender value to decrease during the schedule year. In another embodiment, the variable distribution amount may be calculated as a percentage of the cash surrender value that is less than the indexed crediting rate, thus causing the cash surrender value to increase during the schedule year. For example, and without limitation, the crediting rate may be linked to the Standard & Poor, NASDAQ, or other index. The calculate engine 105 may create yearly records (Block 567) from the projected distribution initiation date through the year when a period of growth of cash reserves through policy maturity begins, defined as a cash value growth threshold date (Block 565). For example, and without limitation, variable distributions may occur for between 10 and 15 years, and/or may sum to equal the total premiums paid (for tax advantage purposes), before shifting focus to cash value growth.

Upon detection by the calculate engine 105 that the current schedule year is the year of the cash value growth threshold date (Block 565), the calculate engine 105 may populate the record for the first possible growth year with a fixed distribution amount (Block 570). For example, and without limitation, the fixed distribution amount may be computed such that the amount withdrawn remains the same every year through the projected policy maturity date, and such that the cash value amount may be allowed to grow through earnings (e.g., compounding interest) to equal the death benefit by the projected maturity date of the policy. The calculate engine 105 may create yearly records (Block 577) from the year of the growth threshold date through the year of policy maturity (Block 575). After the calculate engine 105 creates a record for the year of policy maturity, the SFI schedule calculation subprocess 340 may end at Block 599.

Referring again to FIG. 4, the system interface 400 may be configured to support operators for display (Block 360) of a variety of return schedules according to an embodiment of the present invention. The following operators may be supported by the system interface 400 to allow display of customized output:

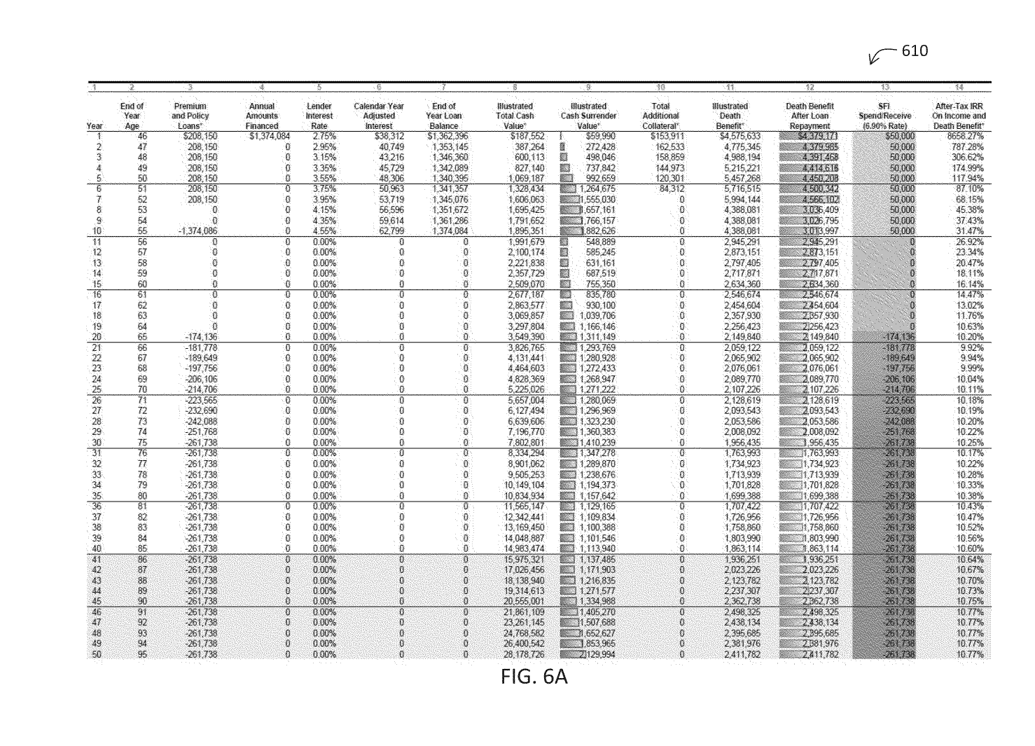

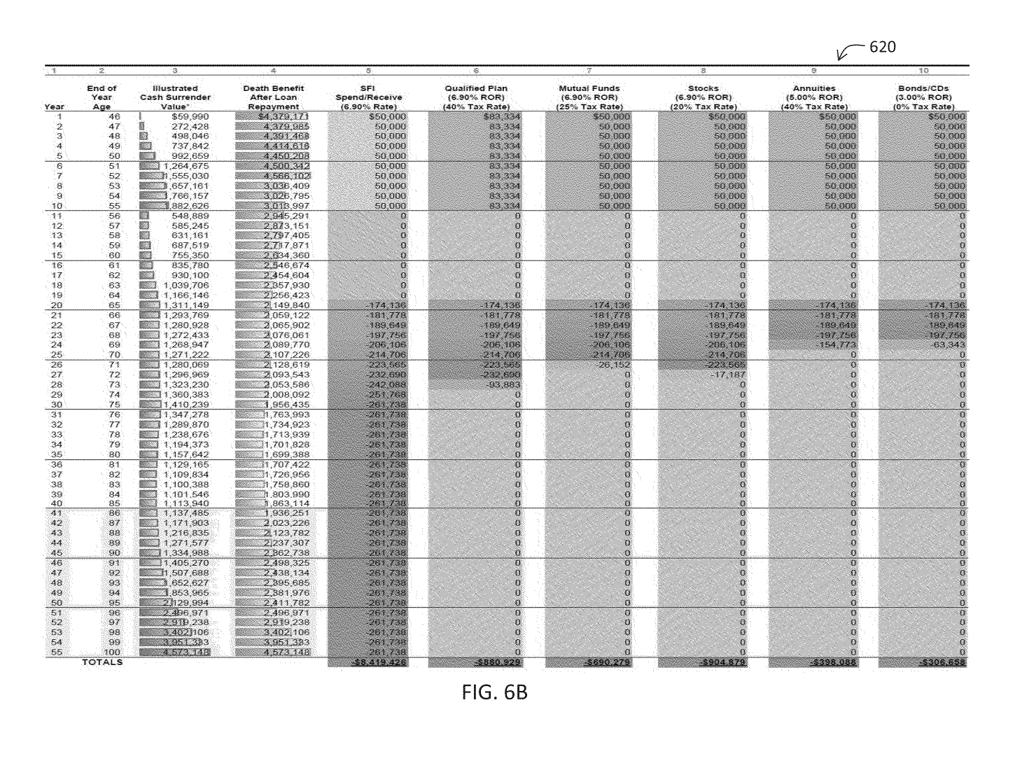

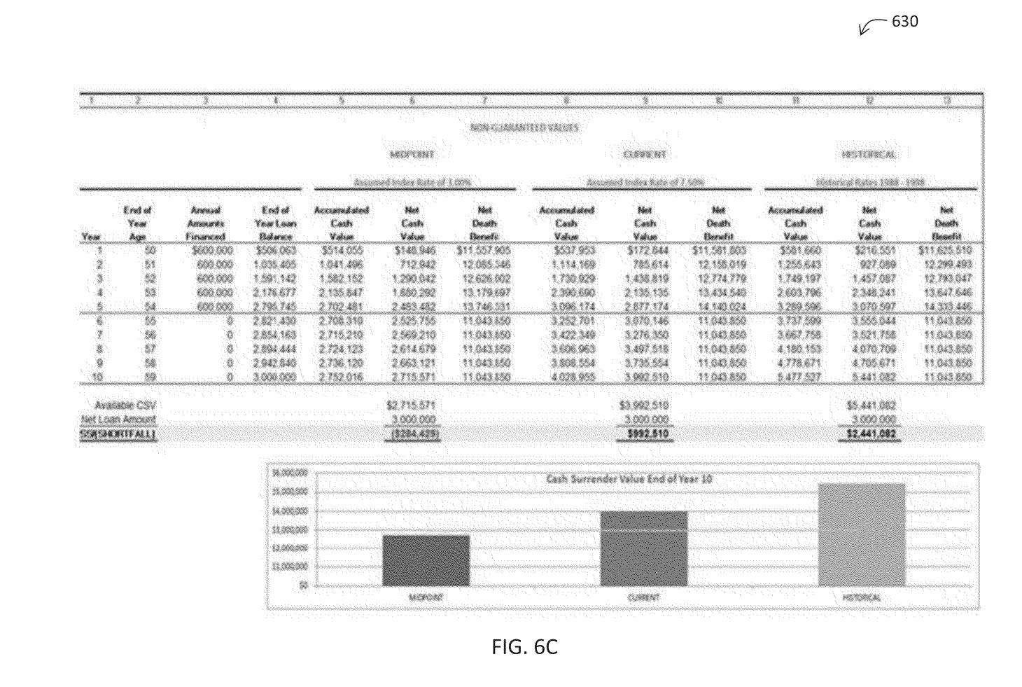

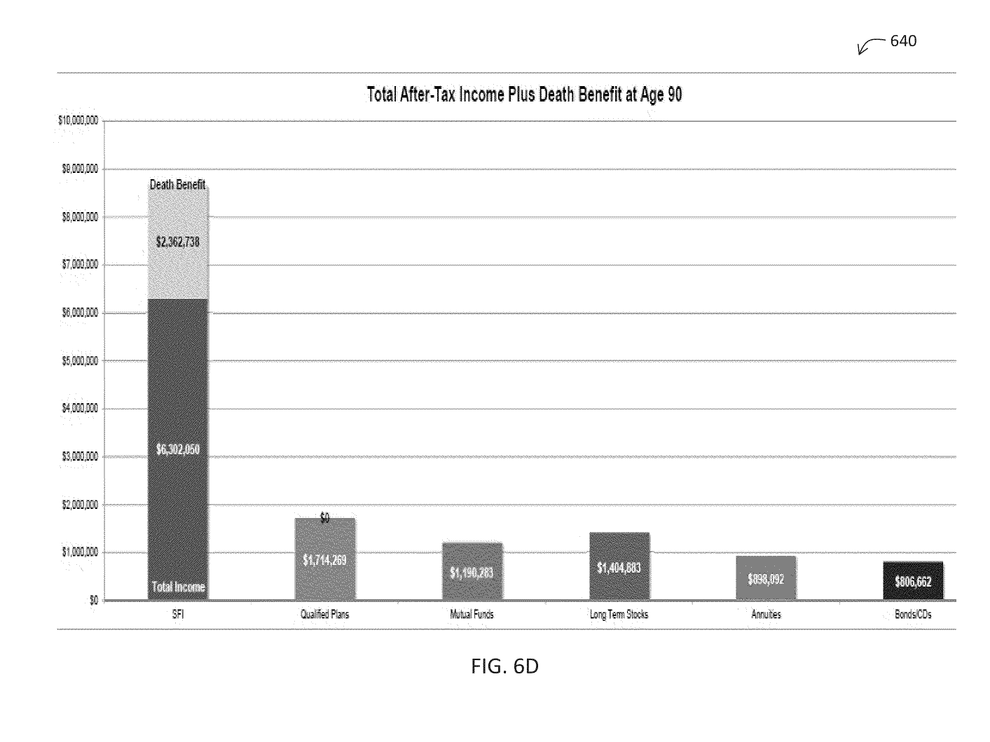

IRR View 460: This operator may allow the user to display calculation results for the SFI schedule of Block 340 and for the alternative investment schedules of Block 350 in the output format of an internal rate of return (IRR). FIG. 6A is a diagram illustrating an exemplary system interface 610 displaying IRR as used in connection with an insurance premium finance planning system according to an embodiment of the present invention.

Customizing Presentation 461: This operator may allow the user to select which alternative investments and other information either to include or to hide in the displayed schedule(s).

Alt View 462: This operator may allow the user to display calculation results for the SFI schedule of Block 340 and for the alternative investment schedules of Block 350 in the output format of an alternative investments comparison view. FIG. 6B is a diagram illustrating an exemplary system interface 620 displaying Alt View as used in connection with an insurance premium finance planning system according to an embodiment of the present invention.

C10 View 463: This operator may allow the user to display calculation results for the SFI schedule of Block 340 and for the alternative investment schedules of Block 350 in the output format of cash value comparison. FIG. 6C is a diagram illustrating an exemplary system interface 630 for displaying cash value comparisons as used in connection with an insurance premium finance planning system according to an embodiment of the present invention.

Age 90 464: This operator may allow the user to display calculation results for the SFI schedule of Block 340 and for the alternative investment schedules of Block 350 in the output format of a total alternative benefits comparison. For example, and without limitation, this operator may total the income and death benefit assuming death at age 90, and compare the SFI returns to those of alternative investments. FIG. 6D is a diagram illustrating an exemplary system interface 640 for displaying alternative benefits comparisons as used in connection with an insurance premium finance planning system according to an embodiment of the present invention.

Age 100 465: The function of this operator may be analogous to that of the Age 90 operator, except that the policy maturity date may coincide with the year of the prospective insured's 100^{th} birthday. The alternative benefits comparisons diagram displayed through this operator is analogous to the diagram 640 of FIG. 6D, except for the maturity date change.

InsChart 466: This operator may total the income and death benefit between to life insurance scenarios, and compare the SFI returns to those of alternative insurance products.

InsView 467: This operator may allow the user to display calculation results for the SFI schedule of Block 340 and for a second insurance product (not shown).

Referring now to the exemplary system interface 610 of FIG. 6A, and continuing to refer to FIGS. 1 and 3, the display of IRR as used in connection with an insurance premium finance planning system according to an embodiment of the present invention will be discussed in greater detail. The following illustrative embodiment is included to provide clarity for one operational method that may be included within the scope of the present invention. A person of skill in the art will appreciate that many variations of an IRR View display may be generated by the present invention, and are intended to be included herein and without limitation.

In one embodiment, the system interface 610 on the consumer client 110 may be used to display calculation results for the SFI schedule of Block 340. For example, and without limitation, the calculated results in schedule 610 reflect a cash value life insurance policy with a policy duration extending from Year 1 (i.e., projected issuance date) through Year 50 (e.g., projected policy maturity date), as shown in the “Year” column of the exemplary schedule 610. In accordance with risk factors that include the prospective insured's age (i.e., age 46 upon the projected issuance date), the policy premium is determined to be $1,374,086 for an initial death benefit of $4,575,633.

As shown in the “Premium and Policy Loans” column of the exemplary schedule 610, the third-party loan amount totaling $1,374,086 is borrowed during the initial leverage period defined as the projected policy issuance date through the projected third-party loan payoff date which, in the present example, is set to Year 10. The premium payment election reflects a plurality of partial premium payments (for example, and without limitation, funded as a respective plurality of third-party loans as elected by the prospective insured) each in the amount of $208,150 spread over the first seven (7) years of the leverage period. During each year of the leverage period, an accrued interest amount is shown in the “Calendar Year Adjusted Interest” column of the exemplary schedule 610.

At the end of the leverage period, an arbitrage period begins with a fixed rate participating policy loan that has, in this example, a rate of 5.0% interest, and that is used to pay off the third-party loan as well as the accrued interest for that third-party loan. From that point forward, the fixed participating policy loan rate is less than the assumed average earnings rate of the cash value life insurance policy (e.g., Indexed Crediting Rate of 6.9%). Furthermore, the third party lender has been fully paid off and no longer has rights of assignment against the policy or against any external collateral. Indeed, the lender is no longer a party to the transaction. In addition, interest rate risk has been eliminated, since the initial third-party variable rate loan has now been replaced by the fixed rate participating policy loan.

As shown collectively in the “End of Year Age” and “Premium and Policy Loans” columns of the exemplary schedule 610, a projected distribution initiation date is set to follow the projected participating policy loan date and, in the illustrated embodiment, to coincide with the prospective insured exceeding the age of 65 years. A variable distribution amount is scheduled for annual deduction from the cash value of the life insurance policy during a period extending from the projected distribution initiation date (shown as Year 20) through a threshold date when recurring annual distribution of a fixed amount begins (shown as Year 30). For example, and without limitation, the fixed distribution amount may be established such that distribution does not result in penalty for the distribution (e.g., reduction in death benefit, tax liability, premium increase).

Both the variable distribution amounts and the fixed distribution amounts are shown as negative numbers in the “Premium and Policy Loans” columns of the exemplary schedule 610. During the time period from the cash value growth threshold date through the projected policy maturity date, the prospective insured may plan on taking the fixed distribution amount annually while at the same time benefiting from growth in the “Illustrated Case Surrender Value” column and, consequently, in the “Illustrated Death Benefit” column, as shown in exemplary schedule 610.

The prospective insured may accept the terms of the SFI plan illustrated in the exemplary schedule 610 by remitting to the insurer a payment toward the policy premium of the cash value life insurance policy.

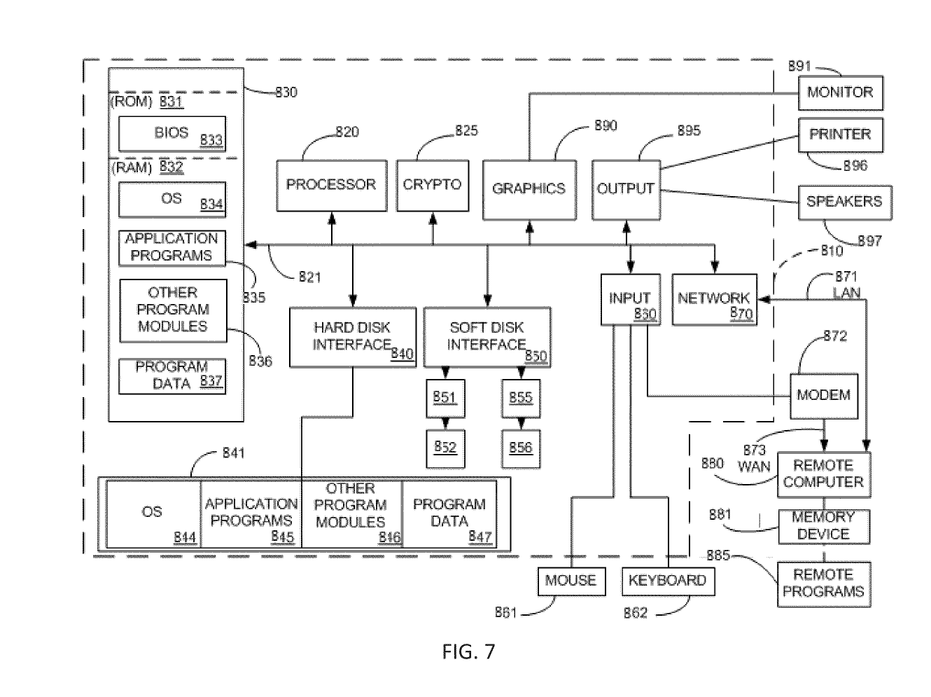

A skilled artisan will note that one or more of the aspects of the present invention may be performed on a computing device. The skilled artisan will also note that a computing device may be understood to be any device having a processor, memory unit, input, and output. This may include, but is not intended to be limited to, cellular phones, smart phones, tablet computers, laptop computers, desktop computers, personal digital assistants, etc. FIG. 7 illustrates a model computing device in the form of a computer 810, which is capable of performing one or more computer-implemented steps in practicing the method aspects of the present invention. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI).

The computer 810 may also include a cryptographic unit 825. Briefly, the cryptographic unit 825 has a calculation function that may be used to verify digital signatures, calculate hashes, digitally sign hash values, and encrypt or decrypt data. The cryptographic unit 825 may also have a protected memory for storing keys and other secret data. In other embodiments, the functions of the cryptographic unit may be instantiated in software and run via the operating system.

A computer 810 typically includes a variety of computer readable media. Computer readable media can be any available media that can be accessed by a computer 810 and includes both volatile and nonvolatile media, removable and non-removable media. By way of example, and not limitation, computer readable media may include computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 7 illustrates an operating system (OS) 834, application programs 835, other program modules 836, and program data 837.

The computer 810 may also include other removable/non-removable, volatile/nonvolatile computer storage media. By way of example only, FIG. 7 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives, and their associated computer storage media discussed above and illustrated in FIG. 7, provide storage of computer readable instructions, data structures, program modules and other data for the computer 810. In FIG. 7, for example, hard disk drive 841 is illustrated as storing an OS 844, application programs 845, other program modules 846, and program data 847. Note that these components can either be the same as or different from OS 833, application programs 833, other program modules 836, and program data 837. The OS 844, application programs 845, other program modules 846, and program data 847 are given different numbers here to illustrate that, at a minimum, they may be different copies. A user may enter commands and information into the computer 810 through input devices such as a keyboard 862 and cursor control device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a graphics controller 890. In addition to the monitor, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 7. The logical connections depicted in FIG. 7 include a local area network (LAN) 871 and a wide area network (WAN) 873, but may also include other networks 140. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 7 illustrates remote application programs 885 as residing on memory device 881.

The communications connections 870 and 872 allow the device to communicate with other devices. The communications connections 870 and 872 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media. Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A decision support method for providing a cash value life insurance policy using reduced-risk premium financing, the method comprising:
receiving an application including application information comprising a projected issuance date, a projected third-party loan payoff date, and a projected policy maturity date;
underwriting the application in accordance with risk factors, wherein the underwriting comprises
determining a policy premium,
determining a third-party loan amount sufficient to fund the policy premium during a leverage period defined as the projected policy issuance date through the projected third-party loan payoff date,
determining a participating policy loan amount sufficient to fund an outstanding loan amount on the projected third-party loan payoff date, the outstanding loan amount comprising the third-party loan amount, and
issuing the cash value life insurance policy upon receipt of a first payment toward the policy premium.

2. The method according to claim 1, wherein the application information comprises a premium payment election selected from a group consisting of a single premium payment and a plurality of partial premium payments.

3. The method according to claim 1, wherein determining the third-party loan amount further comprises determining an accrued interest amount; wherein the outstanding loan amount further comprises the accrued interest amount.

4. The method according to claim 1, wherein the application information comprises a premium financing election selected from a group consisting of a single third-party loan and a plurality of third-party loans.

5. The method according to claim 4, further comprising the step of determining an interest rate differential between the single third-party loan and the plurality of third-party loans.

6. The method according to claim 1, wherein the premium financing election is a single third-party loan; wherein the method further comprises the steps of:
opening a premium deposit fund (PDF) account, and
receiving into the PDF account a deposit amount equal to the third-party loan amount.

7. The method according to claim 1, wherein determining the participating loan amount further comprises determining a maximum participating loan rate that is less than an interest rate for the third-party loan.

8. The method according to claim 7, wherein the maximum participating loan rate comprises a guaranteed fixed loan interest rate.

9. The method according to claim 1, wherein determining the participating loan amount further comprises determining an earnings rate that is greater than the maximum participating loan rate.

10. The method according to claim 1, wherein the method further comprises the step of determining a periodic distribution amount and a projected distribution initiation date.

11. The method according to claim 10, wherein the periodic distribution amount is a variable distribution amount; and wherein the method further comprises the step of scheduling the periodic distribution amount for deduction from a cash value amount of the cash value life insurance policy between the projected participating policy loan date and a cash value growth threshold date.

12. The method according to claim 10, wherein the periodic distribution amount is a fixed distribution amount; and wherein the method further comprises the step of scheduling the fixed distribution amount for deduction from a cash value amount of the cash value life insurance policy between a cash value growth threshold date and the projected policy maturity date.

13. A non-transitory computer-readable medium storing decision support instructions for providing a cash value life insurance policy using reduced-risk premium financing, the instructions, which when executed, cause a processor to perform the steps of:
receiving an application including application information comprising a projected issuance date, a projected third-party loan payoff date, and a projected policy maturity date; and
underwriting the application in accordance with risk factors, wherein the underwriting comprises
computing a policy premium,
computing a third-party loan amount sufficient to fund the policy premium during a leverage period defined as the projected policy issuance date through the projected third-party loan payoff date,
computing a participating policy loan amount sufficient to fund an outstanding loan amount on the projected third-party loan payoff date, the outstanding loan amount comprising the third-party loan amount, and
issuing the cash value life insurance policy upon receipt of a first payment toward the policy premium.

14. The non-transitory computer-readable medium according to claim 13, wherein the application information comprises a premium payment election selected from the group consisting of a single premium payment and a plurality of partial premium payments.

15. The non-transitory computer-readable medium according to claim 13, wherein computing the third-party loan amount further comprises computing an accrued interest amount; wherein the outstanding loan amount further comprises the accrued interest amount.

16. The non-transitory computer-readable medium according to claim 13, wherein the application information comprises a premium financing election selected from a group consisting of a single third-party loan and a plurality of third-party loans.

17. The non-transitory computer-readable medium according to claim 16, wherein the instructions, which when executed, cause the processor to further perform the step of computing an interest rate differential between the single third-party loan and the plurality of third-party loans.

18. The non-transitory computer-readable medium according to claim 16, wherein the premium financing election is the single third-party loan; wherein the instructions, which when executed, cause the processor to further perform the steps of:
opening a premium deposit fund (PDF) account, and
receiving into the PDF account a deposit amount equal to the third-party loan amount.

19. The non-transitory computer-readable medium according to claim 13, wherein computing the participating loan amount further comprises computing a maximum participating loan rate that is less than an interest rate for the third-party loan.

20. The non-transitory computer-readable medium according to claim 19, wherein the maximum participating loan rate comprises a guaranteed fixed loan interest rate.

21. The non-transitory computer-readable medium according to claim 19, wherein computing the participating loan amount further comprises computing an earnings rate that is greater than the maximum participating loan rate.

22. The non-transitory computer-readable medium according to claim 13, wherein the instructions, which when executed, cause the processor to further perform the step of computing a periodic distribution amount and a projected distribution initiation date.

23. The non-transitory computer-readable medium according to claim 22, wherein the periodic distribution amount is a variable distribution amount; wherein the instructions, which when executed, cause the processor to further perform the step of scheduling the periodic distribution amount for deduction from a cash value amount of the cash value life insurance policy between the projected participating policy loan date and a cash value growth threshold date.

24. The non-transitory computer-readable medium according to claim 22, wherein the periodic distribution amount is a fixed distribution amount; wherein the instructions, which when executed, cause the processor to further perform the step of scheduling the fixed distribution amount for deduction from a cash value amount of the cash value life insurance policy between a cash value growth threshold date and the projected policy maturity date.
